(19) United States
(12) Patent Application Publication
(10) Pub. No.: US 2010/0007671 A1
(43) Pub. Date: Jan. 14, 2010

(54) Display system and a display method

(75) Inventor: Ching-Wei Lee, Taoyuan County (TW)

Correspondence Address: BIRCH STEWART KOLASCH & BIRCH, PO BOX 747, FALLS CHURCH, VA, 22040-0747, US

(73) Assignee: Qisda Corporation, Gueishan Hsiang (TW)

(21) Appl. No.: 12/081,596

(22) Filed: Apr. 17, 2008

(30) Foreign Application Priority Data
Apr. 19, 2007 (TW) 096113816

(51) Int. Cl. G06T 1/60

(52) U.S. Cl. 345/530

(57) ABSTRACT

A displaying system and a displaying method are used for displaying surrounding image of the displaying system when the displaying system arrives at a place. There are first image file and first coordinates data correspondingly stored in a storage device in advance. A GPS device in the displaying system is detecting the location coordinates of the displaying system. When the location coordinates and the first coordinates data are very near, the displaying system displays the first image of the first image file.

### BACKGROUND OF THE INVENTION

1. Field of the Invention

The present invention generally relates to a display system and a display method, more particular to a display system and a display method used for retrieving image file by comparing coordinate data.

2. Description of the Prior Art

A positioning system, such as a global positioning system (GPS), is well developed and very convenient for humankind. The global positioning system can generate coordinate data with a artificial satellite and position itself on Earth's surface, this has been widely adopted to the automobile industry. The global positioning systems predetermined stored map data can show the map and location of the car for the driver to know where he is. And the driver can get a clear understanding of which direction he should go.

The above mentioned is a basic technology overview of GPS. The patent number 093203312 “traffic route tracing and manage system” from the Republic of China uses a management module to store the environment image data captured from a camera in a hard disc drive. The management module retrieves the environment image data from the hard disc drive when a far-end user calls the manager module via a communicator. Subsequently, the environment image data retrieved can also be transmitted via the communicator to the far-end user. So the user can monitor the environment image of the car at the far-end position.

However, there are still many inconvenient things about the global positioning system. For instance, the driver knows that he must turn right into a lane by the global positioning system. But he actually sees two lanes on his right side. The reason maybe is that the map data is obsolete. The reason may also be that the environment is too complex for the driver to distinguish.

Therefore, the main purpose of this invention is concerning a display system to retrieve image file by comparing coordinate data and a display method related to solve the above mentioned problem.

### SUMMARY OF THE INVENTION

The primary objective of this invention is to provide a display system and a display method using coordinate data to capture image files. The user can use the pre-stored image files to help distinguish his environment. For the user to compare the images displayed by image files with his actual surroundings in order to make a better judgment.

To achieve the above objective, the present invention provides a display system comprising a storage, a positioning system, a processor, and a display device.

The storage is used for storing a first image file and a first coordinate data corresponding, wherein the first image file is captured at the lotion with the first coordinate data.

The positioning system is used for generating a position coordinate data. The processor retrieves the first image file when the position coordinate data is very near the first coordinate data. That means the distance between the position coordinate data and the first coordinate data lower than a first predetermined value. Then the display device therefore is used for displaying first image file.

Furthermore, the storage stores an image database and a text file. The image database comprises the first image file and a plurality of image file. The text file records party image files of the image database and coordinate data corresponding with the image files. These party image files are chosen previously. These coordinate data corresponding to these records party image files links up a route.

The display system moves along the route. The display device displays the first image file when the first image file existed in the text file and the distance between the position coordinate data and the first coordinate data is lower than a first predetermined value.

The route includes a start point and an end point. The display system further comprises an image capture device. When the display system is in a predetermined situation. The image capture device starts to capture and record a real-time image file in the image database when the display system moves from the start point to the end point. At the same time, a coordinate data corresponding to the real-time image file is generated. The real-time image file and the coordinate data combine to form the text file.

Whereas, the display system and display method of this invention stores the first coordinate data corresponding the image file captured at this location into the storage, and compares the position coordinate data generated from the positioning system with the first coordinate data. The user can clearly distinguish the environment depending on the image file displayed on the display system when the GPS is used.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a display system of the present invention;

FIG. 2 illustrates a storage of the present invention;

FIG. 3 illustrates an image capture device of the display system to capture and generate an image of the present invention;

FIG. 4 illustrates these image files from a database of the display system;

FIG. 5 illustrates another relation figure about these image files from an image database of the display system; and

FIG. 6 illustrates a flowchart of display method of this invention.

### DETAILED DESCRIPTION OF THE INVENTION

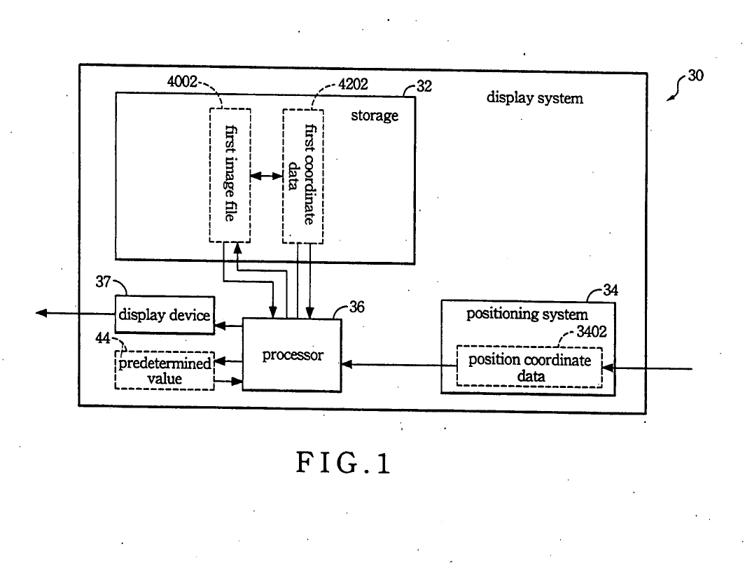

With reference to FIG. 1, which illustrate a display system of the present invention. The display system 30 provided by the present invention is used in a transportation vehicles for positioning the location of the display system and letting the user distinguish the environment. The display system 30 comprises a storage 32, a positioning system 34, a processor 36, and a display device 37.

The storage 32 is used for storing a first image file 4002 and a first coordinate data 4202 corresponding to the first image file 4002. Wherein, the first image file 4002 is captured at the position of the first coordinate data 4202 previously. Then the first image file 4002 be stored in a storage 32 combined with the first coordinate data 4202.

The positioning system 34, for example, such as a global positioning system (GPS), is positioning the location of the display system 30 with an artificial satellite. Then a position coordinate data 3402 generated shows the position of the display system 30. The display system 30 is usually used in vehicles such as a car. Whereby, the position coordinate data 3402 also shows the position of the car.

The processor 36 is used for comparing the position coordinate data 3402 and the first coordinate data 4202. Then the processor 36 retrieves the first image file 4002 when the distance between the position coordinate data 3402 and the first coordinate data 4202 are lower than a first predetermined value 44. The first predetermined value 44 set too large is easier to monitoring for the processor 36 but maybe find some image file useless. If the first predetermined value 44 set too small, the processor 36 will ignore some first image file 4002 important.

Ordinarily, the display device 37 shows the map depending on a map data, and shows the location of the car on the map by the position coordinate data 3402. Besides, the display device 37 of the present invention further displays the image of the first image file 4002 retrieved from the processor 36.

When the driver arrives the position of the first coordinate data 4202, sometimes, the driver can't distinguish the environment depending on the GPS map because the map data is obsolete. At this time the driver can distinguish the environment assisted by the image generated from the first image file 4002 displayed on the display device 37.

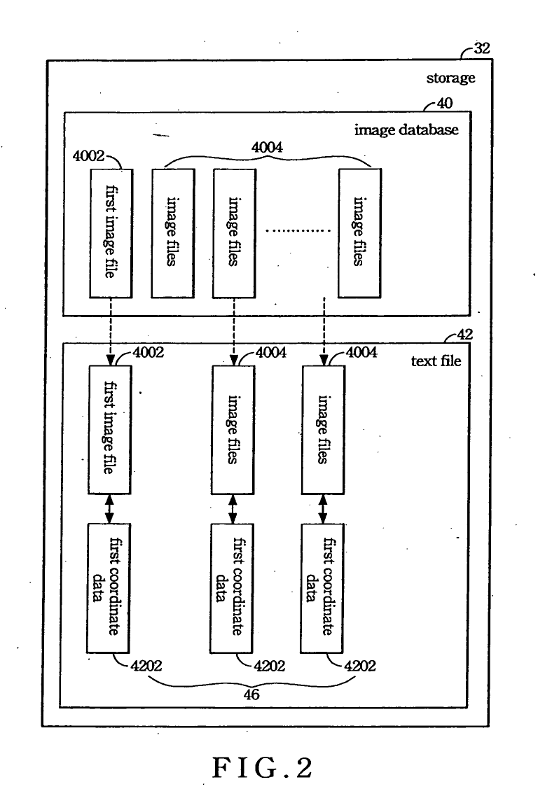

With reference to FIG. 2, which illustrates storage of the present invention of the present invention. The storage 32 stores an image database 40 and a text file 42. The image database 40 comprises the first image file 4002 and a plurality of other image files 4004. Party of these image files 4004 within the image database 40 and these coordinate data 4202 corresponding to the image files 4002, 4004 are recorded in the text file 42, Wherein, these multiple coordinate data 4202 of the text file 42 links to a route 46.

When the car with the display system 30 moves along the route 46. The display device 37 displays the image of the first image file 4002 for the driver when the distance between the position coordinate data 3402 and the first coordinate data 4202 is lower than the first predetermined value 44. That means that the driver arrives at the position of the first coordinate data 4202.

A word or a sentence also can be recorded in the text file 42 and link to the first coordinate data 4202 and the first image file 4002. When the driver arrives at the position of the position coordinate data 3402, the display system 30 either can display the first image file 4002 or can speak a voice about that word or that sentence such as “turn right please”. The voice is generated by the skill of “text-to-speech; TTS”.

The text file 42 can show as following form:

Image 1.jpg, E: 121° 31′, N: 25° 04′
Image 2.jpg, E: 121° 31′, N: 25° 05′
turn right please, E: 121° 31′, N: 25° 05′
Image 3.jpg, E: 121° 31′, N: 25° 05′
Image 4.jpg, E: 121° 32′, N: 25° 05′
Image 5.jpg, E: 121° 33′, N: 25° 05′

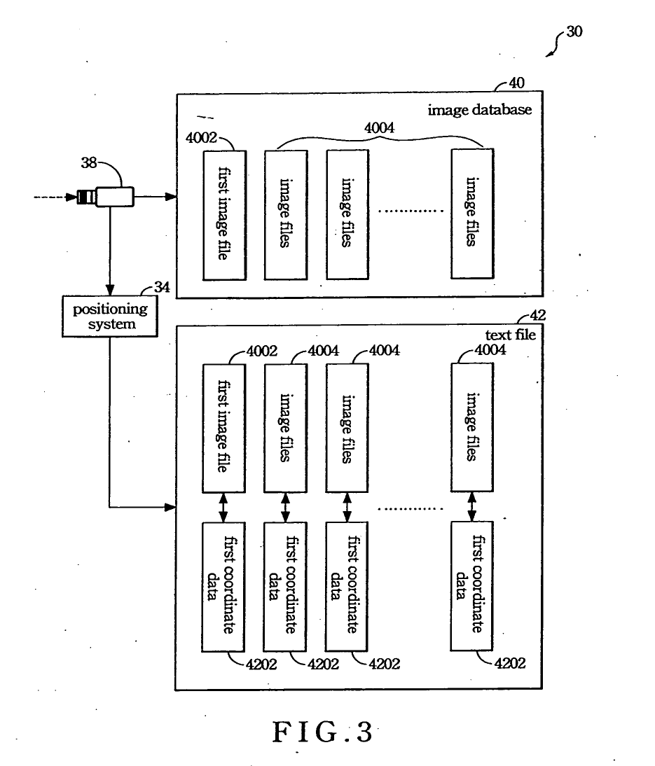

With reference to FIG. 3, which illustrates an image capture device of the display system to capture and generate an image of the present invention, further describes about “the first image file 4002 is captured at the position of the first coordinate data 4202 previously”. The route 46 includes a start point and a end point. The display system 30 further comprises an image capture device 38 such as a camera. When the display system 30 in a predetermined situation, the image capture device 38 starting to capture and record a real-time image file in the image database 40 when the display system 30 moving from the start point to the end point. So the real-time image file means the first image file 4002 and said a plurality of image files 4004 in the image database 40 above mentioned.

The display system 30 further recording the real-time image file and the coordinate data corresponding to the real-time image file in the text file 42. The coordinate data is generated from the positioning system 34. That is the image file 4002, 4202 and the coordinate data 4206 in the text file 42 above mentioned.

There are many kinds of the predetermined situation. One is changing the direction. When the car turn right or left, the direction of the display system 30 moving and changing over a predetermined angle. That may means one kind of the predetermined situation. Usually when the car turn a corner, the driver needs to distinguish the environment. It is the timing for capturing the image to record as the real-time image file. In fact, the predetermined angle can be set previously, such as 30 or 45 or 90 degrees.

The predetermined situation can mean every period. The image capture device 38 can captures the image to generate the image file in every period. That also can let the driver to make sure about that the environment is same as the image or not. Furthermore, the predetermined situation can mean every predetermined distance. The image capture device 38 captures the image every predetermined distance. This can avoid parking too long time to capture too many same images.

The predetermined situation also can be a feature image. That means the image captured from the image capture device 38 matching the feature image. Generally, an advertisement board or a building is more worthy for image capture device 38 to capture, because the advertisement board and the building are more obviously. The advertisement board and the building have a same feature that is a long line. The edge of the advertisement board or the building is the long line. So the display system 30 can treat the long line as the feature image when the length of the long line is over a predetermined value. Even sometimes the display system 30 captures some images not really the advertisement board or the building, but it is still utility for sometimes capturing really the advertisement board or the building.

Further describing, after the image capture device 38 captures the image, the image capture device 38 transfers the RGB color to the YUV color. Then the display system 30 detects the long line in the YUV image. If a line is long enough, the display system 30 determines the line is the feature image.

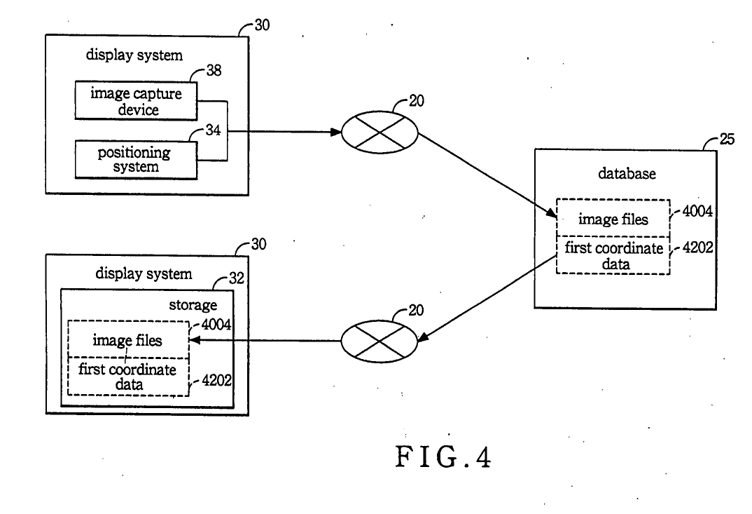

With reference to FIG. 4, which illustrates these image files from a database of the display system. The image captured by the image capture device 38 can store in a far end database 25 that is couples the display system 30 by network 20. When the driver needs these images, he can down loaded the image from a far end database 25 via the network 20 to the storage 32 of the display system 30. Said network 20 could be internet or intranet.

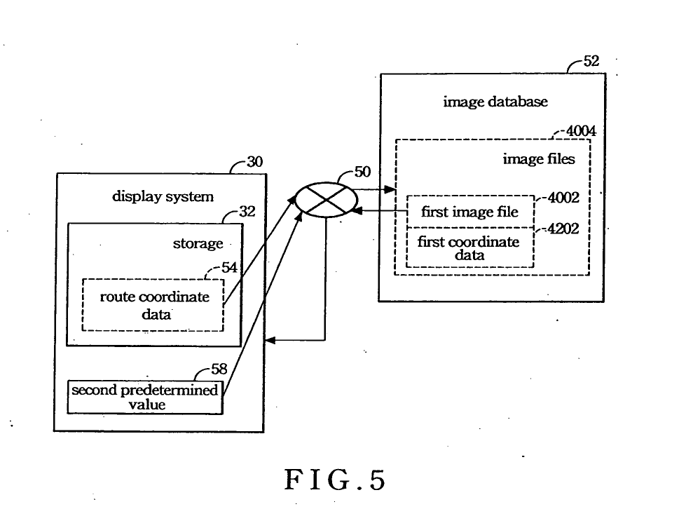

With reference to FIG. 5, which illustrates another relation figure about these image files from an image database of the display system. In one instance of the present invention, a route coordinate data 54 is predetermined stored in the storage 32. There are multiple image files 4004 stored in a for end image database 52.

The display system 30 can compare the coordinate data of these image files 4004 with the route coordinate data 54 via the network 50 when the display system 30 moves along with the predetermined route. The display system 30 will treat the image file 4004 as the first image file 4002 above mentioned when the distance between the coordinate data of the image file 4004 and the route coordinate data 54 is lower than a second predetermined value 58. Then the coordinate data of the image file 4004 is first coordinate data 4202. These multiple first image files 4002 and first coordinate data 4202 corresponding are down loaded from the image database 52 to the display system 30. Subsequently, the display system 30 will operate as above mentioned. Wherein, the second predetermined value 58 is maybe same to the first predetermined value 44 or not.

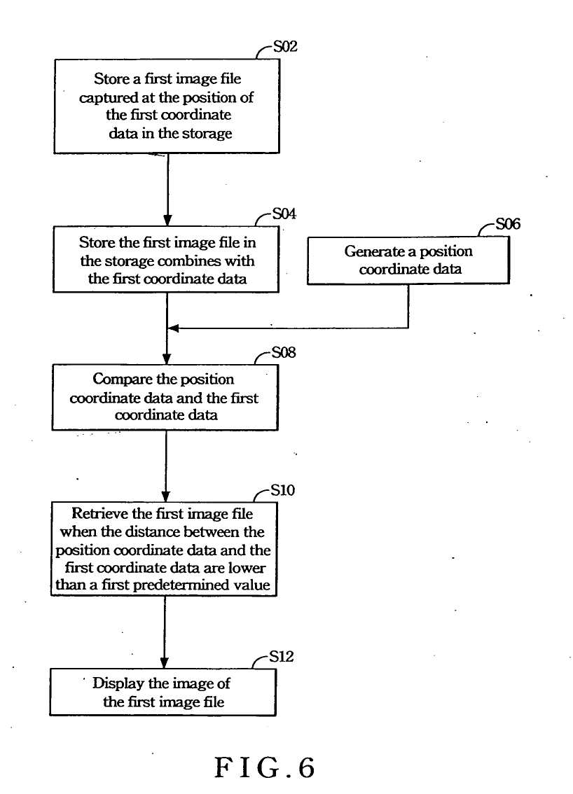

With reference to FIG. 6, which illustrates a flowchart of display method of this invention. This invention also is a display method operated by the display system 30. The display method comprises following steps:

Step S02: A first image file 4002 is stored in the storage 32. The first image file 4002 is captured at the position of the first coordinate data 4202 previously.

Step S04: The first image file 4002 stored in the storage 32 combines with the first coordinate data 4202.

Step S06: Then a position coordinate data 3402 generated shows the position of the display system 30. The position coordinate data 3402 also shows the position of the car.

Step S08: The processor 36 compares the position coordinate data 3402 and the first coordinate data 4202.

Step S10: Then the processor 36 retrieves the first image file 4002 when the distance between the position coordinate data 3402 and the first coordinate data 4202 are lower than a first predetermined value 44.

Step S12: The display device 37 shows the map depending on a map data, and shows the location of the car on the map by the position coordinate data 3402. Besides, the display device 37 of the present invention further displays the image of the first image file 4002 retrieved from the processor 36.

Point to the Step S02 and S04, further comprises the step of storing an image database 40 and a text file 42. The image database 40 comprises the first image file 4002 and another multiple image files. Party of these image files 4004 within the image database 40 and these coordinate data 4202 corresponding to the image files 4002, 4004 are recorded in the text file 42. Wherein, these multiple coordinate data 4202 of the text file 42 links to a route 46.

When the car with the display system 30 moves along the route 46. The display device 37 displays the image of the first image file 4002 for the driver when the distance between the position coordinate data 3402 and the first coordinate data 4202 is lower than the first predetermined value 44. That means that the driver arrives at the position of the first coordinate data 4202.

The route 46 includes a start point and an end point. The display method further comprises a step of. When the display system 30 in a predetermined situation, the image capture device 38 starting to capture and record a real-time image file in the image database 40 when the display system 30 moving from the start point to the end point. The display system 30 further recording the real-time image file and the coordinate data corresponding to the real-time image file in the text file 42.

The predetermined situation may be the direction of the display system 30 moving and changing over a predetermined angle. The predetermined situation may be the display system 30 capturing the image to generate the image file in every period. The predetermined situation also can mean every predetermined distance. Otherwise, the predetermined situation also can be a feature image.

As a conclusion, the present invention adopts the display system 30 and display method to store the first coordinate data 4202 corresponding the image file captured at this location into the storage 32, and compares the position coordinate data 3402 generated from the positioning system 34 with the first coordinate data 4202. The user can clearly distinguish the environment depending on the image file displayed on the display system 30 when the GPS is used.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A display system, comprising:
a storage used for storing a first image file and a first coordinate data corresponding to the first image file, wherein the first image file captured at a location of the first coordinate data previously;
a positioning system used for generating a position coordinate data;
a display device; and
a processor retrieving the first image file and displaying on the display device when a distance between the position coordinate data and the first coordinate data lower than a first predetermined value.

2. The display system according to claim 1, wherein the storage storing an image database and a text file, the image database comprising the first image file and a plurality of other image files, the text file recording a portion of image files within the image database and a plurality of coordinate data corresponding to the portion of image files, wherein the coordinate data links to a route.

3. The display system according to claim 2, when the display system moving along the route, the display device displaying the first image file when the first image file existing in the text file and the distance between the position coordinate data and the first coordinate data lower than the first predetermined value.

4. The display system according to claim 2, wherein the route including a start point and a end point, the display system further comprising:
an image capture device;
Wherein, when the display system in a predetermined situation, the image capture device starting to capture and record a real-time image file in the image database when the display system moving from the start point to the end point, the display system further recording the real-time image file and the coordinate data corresponding to the real-time image file in the text file.

5. The display system according to claim 4, wherein said predetermined situation is a direction changing of the display system moving over a predetermined angle.

6. The display system according to claim 4, wherein said predetermined situation is periodical.

7. The display system according to claim 4, wherein said predetermined situation is the image captured from the image capture device matching a feature image.

8. The display system according to claim 1, wherein the display system couples with a database, the first image file and the first coordinate data down loading from the database.

9. The display system according to claim 1, wherein the storage stores a route coordinate data, the display system retrieving a plurality of first image files from a image database when a distance between said first coordinate data and the route coordinate data lower than a second predetermined value.

10. A display method for a display system, comprising following steps:
storing a first image file, wherein the first image file is captured at the position of a first coordinate data;
storing the first coordinate data, wherein the first coordinate data is corresponding the first image file;
generating a position coordinate data of the display system;
comparing the position coordinate data and the first coordinate data, retrieving the first image file when a distance between the position coordinate data and the first coordinate data lower than a first predetermined value; and
displaying the first image file.

11. The display method according to claim 10, wherein the display method further comprising:
storing an image database and a text file, the image database comprising the first image file and a plurality of other image files; recording a portion of the image files within the image database and a plurality of coordinate data corresponding to the image files recorded in the text file, wherein the coordinate data links to a route.

12. The display method according to claim 11, further comprising:
when the display system along the route, displaying the first image file when the first image file existing in the text file and the distance between the position coordinate data and the first coordinate data lower than the first predetermined value.

13. The display method according to claim 11, wherein the route including a start point and a end point, when the display method processes in a predetermined situation, then starting to capture and record a real-time image file in the image database during the time of moving from the start point to the end point, furthermore recording the real-time image file and the coordinate data corresponding to the real-time image file in the text file.

14. The display method according to claim 13, wherein said predetermined situation is the direction changing of the display system moving over a predetermined angle.

15. The display method according to claim 13, wherein said predetermined situation is periodical.

16. The display method according to claim 13, wherein said predetermined situation is the image captured from the image capture device matching a feature image.

17. The display method according to claim 1, wherein the display method further comprising following step, down loading the first image file and the first coordinate data from the database.

18. The display method according to claim 10, further comprising:
predetermining a route coordinate data ; and
retrieving a plurality of first image files from a image database when a distance between said first coordinate data and the route coordinate data lower than a second predetermined value.
